(19) United States
(12) Patent Application Publication
(10) Pub. No.: US 2008/0298484 A1
(43) Pub. Date: Dec. 4, 2008

(54) Method and apparatus for detecting transmit signals in receiver in multiple-input multiple-output communication system

(75) Inventor: Shi-Chang Rho, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co. Ltd.

(21) Appl. No.: 11/984,368

(22) Filed: Nov. 16, 2007

(30) Foreign Application Priority Data
May 28, 2007 (KR) 10-2007-0051697

(51) Int. Cl. H04L 27/28

(52) U.S. Cl. 375/260

(57) ABSTRACT

A method and apparatus for detecting a transmit signal in a receiver in a multiple-input multiple-output (MIMO) system are provided. The method includes: dividing a constellation space into a plurality of sub-spaces, the constellation space being determined by a channel matrix, which indicates channel characteristics of the MIMO communication system, and the number of antennas; and detecting the transmit signal by calculating a metric of at least one of the sub-spaces. The apparatus includes: a channel estimation unit which estimates channel characteristics of the MIMO communication system; a preprocessing unit which preprocesses the estimated channel-characteristic data; and a signal detection unit which processes a received signal measured by the receiver using the preprocessed channel-characteristic data, divides a constellation space used to detect the transmit signal into sub-spaces, and executes a statistical algorithm on at least one of the sub-spaces.

### CROSS REFERENCE TO RELATED APPLICATIONS

This application claims priority from Korean Patent Application No. 10-2007-0051697, filed on May 28, 2007, the disclosure of which is incorporated herein in its entirety by reference.

### BACKGROUND OF THE INVENTION

1. Field of the Invention

Methods consistent with the present invention relate to a wireless communication system, and more particularly, to a method and apparatus for detecting transmit signals in a receiver in a multiple-input multiple-output (MIMO) communication system which uses multiple antennas.

2. Description of the Related Art

In a wireless communication system, as each transmitted signal passes through a channel which consists of multiple paths between a transmitter and a receiver, the signal is subjected to distortion on its way to the receiver due to attenuation, noise, etc. Hence the receiver should detect the original signal using the distorted signal and the channel characteristics.

In addition to single-input single-output (SISO) communication systems which use one antenna, many studies are currently being conducted on multiple-input multiple-output (MIMO) communication systems. MIMO communication systems offer a significant increase in data throughput without using additional bandwidth or transmit power by sending data by multiple transmit antennas. However, in the MIMO communication system, the receiver has to perform a large amount of operations to give an accurate detection of a transmit signal and is often very complex to design.

For instance, the MIMO communication system employs a sequential signal detection method to detect the transmit signal. However, in the case of low signal-to-noise ratio (SNR), the sequential signal detection method has to deal with a large amount of operations in all constellation spaces, which may cause poor system throughput and fluctuating latency in detecting the transmit signals.

### SUMMARY OF THE INVENTION

The present invention provides a method and apparatus for detecting transmit signals in a multiple-input multiple-output (MIMO) communication system by processing received signals measured by a receiver in the MIMO communication system and dividing a space for constellation points into sub-spaces to detect the transmit signals.

The present invention further provides a method and apparatus for detecting transmit signals in a MIMO communication system which has a receiver that prevents latency in detecting transmit signals by making early termination of metric calculation on constellation sub-spaces so that the buffer temporarily storing received signals cannot overflow.

Additional aspects of the invention will be set forth in the description which follows, and in part will be apparent from the description, or may be learned by practice of the invention.

The present invention discloses a method of detecting a transmit signal in a receiver in a multiple-input multiple-output (MIMO) system, the method including: dividing a constellation space into a plurality of sub-spaces, the constellation space being determined by a channel matrix, which indicates channel characteristics of the MIMO communication system, and the number of antennas; and detecting the transmit signal by calculating a metric of at least one of the sub-spaces.

The operation of detecting the transmit signal may include making early termination of the metric calculation based on a condition of a buffer which temporarily stores signals measured by the receiver.

The present invention also discloses a method of detecting a transmit signal in a receiver in a multiple-input multiple-output (MIMO) system, including: preprocessing estimated channel characteristics of the MIMO communication system; processing received signals measured by the receiver using the preprocessed channel-characteristic data and dividing a constellation space used to detect the transmit signal into sub-spaces; and detecting the transmit signal by executing a statistical algorithm on at least one of the sub-spaces.

The present invention also discloses an apparatus for detecting a transmit signal in a receiver in a multiple-input multiple-output (MIMO) system, including: a channel estimation unit which estimates channel characteristics of the MIMO communication system; a preprocessing unit which preprocesses the estimated channel-characteristic data; and a signal detection unit which processes a received signal measured by the receiver using the preprocessed channel-characteristic data, divides a constellation space used to detect the transmit signal into sub-spaces, and executes a statistical algorithm on at least one of the sub-spaces to detect the transmit signal.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 is a schematic diagram of a MIMO communication system which uses multiple antennas.

FIG. 2 is a block diagram of an apparatus for detecting transmit signals according to an exemplary embodiment of the present invention.

FIG. 3 is a block diagram of a signal detection unit shown in FIG. 2.

FIG. 4 is a schematic diagram for explaining a sequential signal detection method which is applicable to the present invention.

FIGS. 5A to 5D illustrate sub-spaces divided depending on the sub-space size and overlap degree.

FIG. 6 illustrates sub-space division in 16-QAM.

FIG. 7 is a flow chart of a method of detecting transmit signals according to an exemplary embodiment of the present invention.

### DETAILED DESCRIPTION OF EXEMPLARY EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

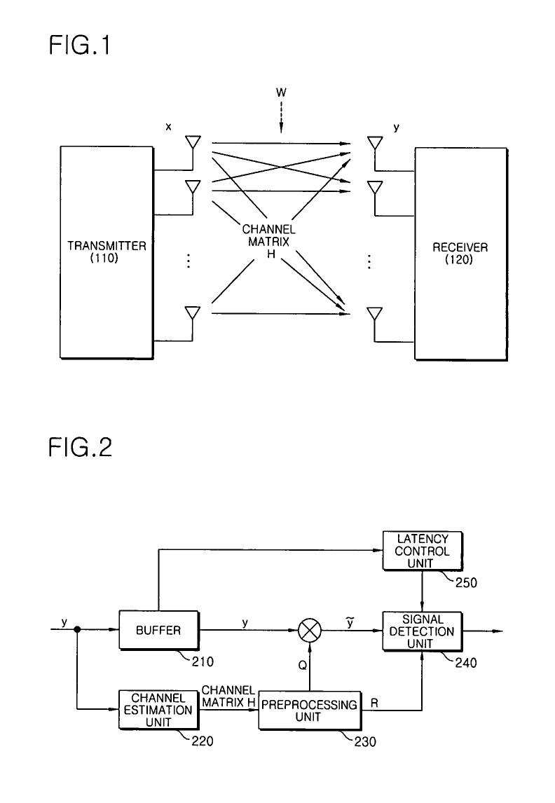

FIG. 1 is a schematic diagram of a MIMO communication system which uses multiple antennas.

A multiple-input multiple-output (MIMO) communication system uses multiple antennas both at a transmitter 110 and at a receiver 120 to transmit and receive multiple signals. For instance, while a conventional wireless LAN uses a single antenna oriented in an appropriate direction for an access point (AP) which connects wired and wireless networks to each other even though it can have multiple antennas, the MIMO communication system employs multiple antennas to enable high-rate data exchange between the transmitter and receiver.

In other words, both the transmitter 110 and the receiver 120 can carry out high-rate data exchange by transmitting and receiving data over their respective multiple antennas. The MIMO communication system can be expressed by equation 1 below:

y=Hx+w (1)

where y denotes a signal vector received by the receiver 120, x denotes a transmit signal vector transmitted by the transmitter 110, w denotes an additive white Gaussian noise (AWGN), and H denotes an nR×nT channel matrix indicating channel characteristics, nT being the number of transmit antennas and nR being the number of receive antennas.

FIG. 2 is a block diagram of an apparatus for detecting transmit signals according to an exemplary embodiment of the present invention.

The apparatus includes a buffer 210, a channel estimation unit 220, a preprocessing unit 230, a signal detection unit 240, and a latency control unit 250. Here, the latency control unit 250 may be omitted.

The signal y measured by the receiver is input to the buffer 210. The channel estimation unit 220 estimates the channel matrix H, which indicates channel characteristics. The preprocessing unit 230 decomposes the channel matrix H into Q and R, i.e., H=QR. Here, the matrix Q is defined as a matrix whose product with the Hermitian matrix of Q, Q^{H}, becomes an identity matrix.

The signal detection unit 240 detects a transmit signal using channel information processed by the preprocessing unit 230 and the measured signal y. That is, the product of the signal y and the Hermitian matrix of Q, Q^{H}, is expressed below by equation 2 (here, the received signal is represented in an upper-triangle matrix form):

$$\begin{matrix}{Q}^{H} y = R x + \hat{w} \\ [ \begin{matrix}{y}_{1} \\ {y}_{2} \\ {y}_{3}\end{matrix} ] = [ \begin{matrix}{r}_{11} & {r}_{12} & {r}_{13} \\ 0 & {r}_{22} & {r}_{23} \\ 0 & 0 & {r}_{33}\end{matrix} ] [ \begin{matrix}{x}_{1} \\ {x}_{2} \\ {x}_{3}\end{matrix} ] + \hat{w}\end{matrix} \qquad ( 2 )$$

It can be seen from equation 2 that a sequential algorithm can be used to detect the transmit signal. That is, the transmit signal can be detected by sequentially obtaining x₃, using x₃ to calculate x₂, and then using x₂ to calculate x₁. While the present embodiment of the invention concerns a case to which the sequential algorithm is applicable, other algorithms employed in a general MIMO communication system can be used. The signal detection unit 240 does not carry out the sequential algorithm on all constellation points. Instead, the signal detection unit 240 detects the transmit signal by dividing a space for constellation points, which are used in detecting the transmit signal, into sub-spaces and implementing the following statistical algorithm on only part of the sub-spaces.

In this case, the transmit signal may be detected by dividing the space for constellation points into sub-spaces in such a manner that neighboring sub-spaces partly overlap, and implementing the statistical algorithm on one or more of the sub-spaces.

The latency control unit 250 checks the buffer 210 into which the measured signal is input, and makes early termination of metric calculation so that the buffer 210 cannot overflow. The latency control unit 250 is optional and may be omitted. That is, the transmit signal may be detected according to the above-mentioned sub-space division method without checking the buffer 210.

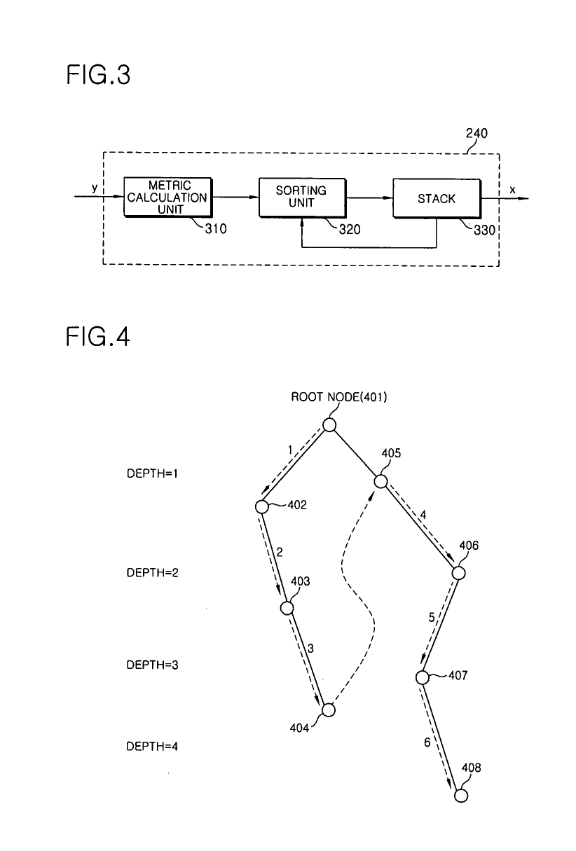

FIG. 3 is a block diagram of the signal detection unit 240 shown in FIG. 2.

The signal detection unit 240 includes a metric calculation unit 310, a sorting unit 320, and a stack 330.

In FIG. 3, a stack algorithm, which is a type of sequential signal detection algorithm, is used to detect the transmit signal. The sequential signal detection algorithm is configured to calculate metrics between higher and lower nodes in a tree structure, where each node has a different depth depending on the number of antennas. The metric calculation is made by the metric calculation unit 310. The sorting unit 320 sorts out metric values and the stack 330 stores the sorted metric values. The sorting unit 320 updates the stack 330 according to the sorting results, and reuses the updated metric values. The sequential signal detection by the stack algorithm will be described in detail with reference to FIG. 4.

In the case of the sequential signal detection algorithm, a partial Euclidean distance (PED) may be calculated for the metric calculation between the nodes. PED is calculated according to equation 3 below:

$${T}_{i} ( {s}^{( i )} ) = {T}_{i + 1} ( {s}^{( i + 1 )} ) + {\vert {e}_{i} ( {s}^{( i )} ) \vert}^{2} , ( i = {M}_{T} , {M}_{T} - 1 , … , 1 ) \\ {\vert {e}_{i} ( {s}^{( i )} ) \vert}^{2} = {\vert {b}_{i + 1} ( {s}^{( i + 1 )} ) - {R}_{ii} {x}_{i} \vert}^{2} \\ with \\ {b}_{i + 1} ( {s}^{( i + 1 )} ) = {\hat{y}}_{i} - {\sum }_{j = i + 1}^{{M}_{r}} {R}_{ij} {x}_{j} \qquad ( 3 )$$

The PED calculation is well known in the art and its description will be omitted.

FIG. 4 is a schematic diagram for explaining a sequential signal detection method which is applicable to the present invention.

First, metrics between a root node 401 and each lower node are calculated. A node 402 having the smallest of the calculated metric values is selected. Unless the smallest value exceeds a predetermined value, metrics between the node 402 and each lower node are calculated. If a node 403 has the smallest of the calculated metric values, it is determined whether or not the smallest value exceeds a predetermined value. If not, metrics between the node 403 and each lower node are calculated and a node 404 having the smallest of the calculated metric values is selected.

If the metric of the node 404 exceeds a predetermined value, the process returns to a higher node to calculate metrics and select another node. While the process returns to the highest node in FIG. 4, it may return to the preceding node.

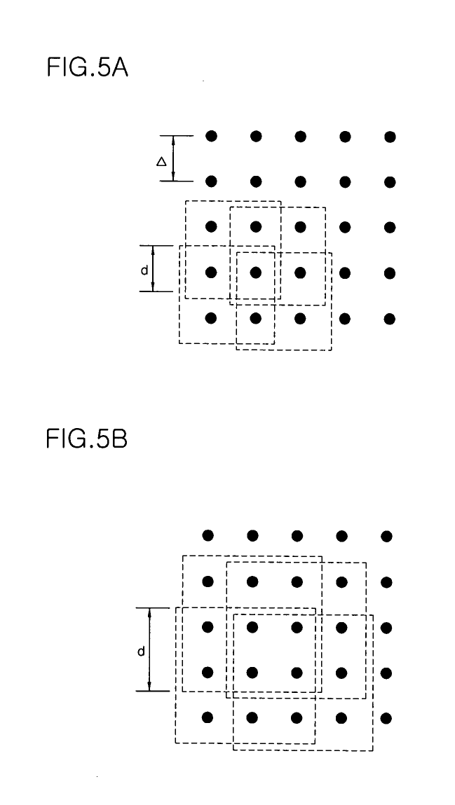

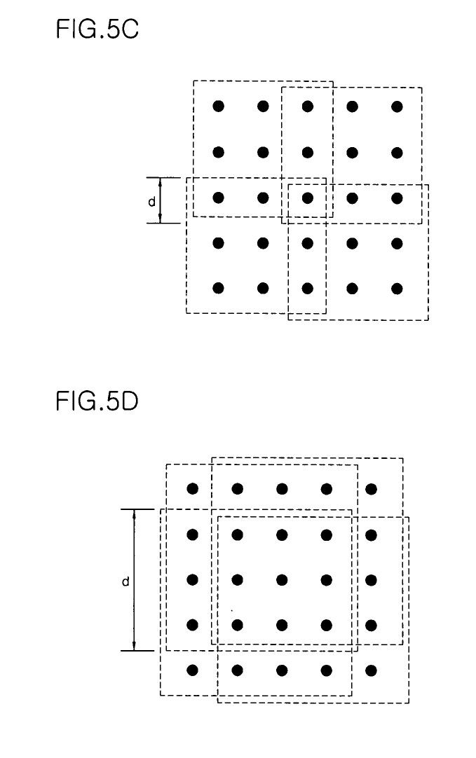

FIGS. 5A to 5D illustrate sub-spaces divided depending on the sub-space size and overlap distance.

The sub-space division may be differently made depending on the sub-space size and the overlap distance between sub-spaces.

In FIG. 5A, the sub-space size is 4 and the overlap distance is equal to a distance Δ between neighboring constellation points. In FIG. 5B, the sub-space size is 9 and the overlap distance is 2Δ. In FIG. 5C, the sub-space size is 9 and the overlap distance is Δ. In FIG. 5D, the sub-space size is 16 and the overlap distance is 3Δ.

According to the present embodiment of the invention, the signal detection algorithm, such as the sequential detection algorithm, is executed on only some of the sub-spaces thus obtained. Therefore, the frequency of node-visiting is reduced, thereby reducing the amount of calculations.

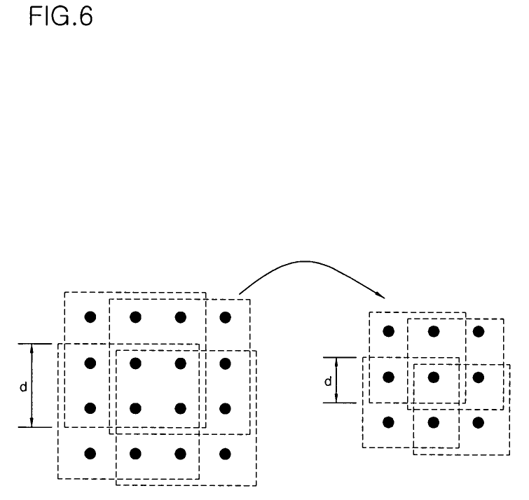

FIG. 6 illustrates sub-space division in 16-QAM.

In FIG. 6, there are 16 constellation points in 16-QAM. The constellation space is divided into four sub-spaces with a sub-space size of 9 and an overlap distance d of two constellation points. Each sub-space is further divided into four sub-spaces with a sub-space size of 4 and an overlap distance d of one constellation point.

Table 1 below shows the sub-space division based on the modulation order.

TABLE 1

| | | | Number of constellation | Number of |
|---|---|---|---|---|
| | s | d[D] | points in each sub-space | sub-spaces |
| 16-QAM | 4 | 0 | 4 | 4 |
| | | 1 | 4 | 9 |
| | 9 | 2 | 9 | 4 |
| | 16 | 0 | 16 | 1 |
| 64-QAM | 4 | 0 | 4 | 16 |
| | | 1 | 4 | 49 |
| | 9 | 2 | 9 | 25 |
| | 16 | 0 | 16 | 4 |
| | | 2 | 16 | 9 |
| | | 3 | 16 | 16 |
| | 25 | 2 | 25 | 4 |
| | 36 | 4 | 36 | 4 |
| | 49 | 6 | 49 | 4 |
| | 64 | 0 | 64 | 1 |

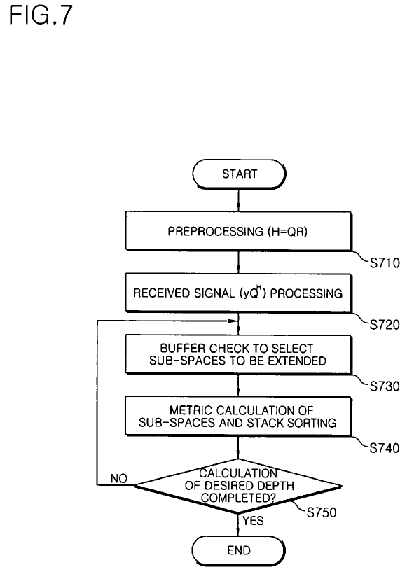

FIG. 7 is a flow chart of a method of detecting transmit signals according to an exemplary embodiment of the invention.

In operation S710, the preprocessing operation is performed to decompose the channel matrix H into Q and R using estimated channel characteristics of the MIMO communication system. In operation S720, the product of the received signal y measured by the receiver and the Hermitian matrix of Q is obtained.

In operation S740, a space for constellation points, which are used to detect the transmit signal, is divided into sub-spaces, and the statistical algorithm is executed on at least one of the sub-spaces to detect the transmit signal. At this time, in operation S730, the buffer temporarily storing the received signal may be checked to select sub-spaces to be extended so that the buffer cannot overflow by making early termination of the subsequent calculation operation.

In operation S750, it is determined whether or not a calculation is made to reach a depth corresponding to the number of antennas of the MIMO communication system. If the calculation is completed, the process is terminated. Otherwise, the process returns to operation S730.

On the other hand, the space may be divided into sub-spaces in such a manner that neighboring sub-spaces partly overlap. In this case, the space is divided based on the sub-space size and overlap distance, as shown in FIGS. 5A to 5D.

In addition, the statistical algorithm may be executed on one or more of the sub-spaces to detect the transmit signal.

The above-mentioned method according to the present embodiment of the invention may be stored in any form of recording media, such as CD-ROM, RAM, ROM, floppy disk, hard disk, or magneto-optical disk, or in any computer-readable form, such as computer code organized into executable programs. Methods of storing an exemplary embodiment of the present invention are well known in the art and thus descriptions will be omitted.

As apparent from the above description, according to the above-mentioned exemplary embodiments of the present invention, the receiver of the MIMO communication system is designed with a simpler structure than the conventional receiver, and exhibits a similar performance to the conventional receiver which makes a metric calculation with all constellation points. Accordingly, the present invention can be applied to future systems as well as current systems, such as IEEE802.11n, IEEE802.16e, and WiBro.

Furthermore, conventionally, the calculations for signal detection become more complex and increase exponentially as the constellation size grows larger. However, according to the present invention, it is possible to lower the complexity of calculations by controlling the sub-space size and the number of constellation points.

In addition, it is possible to reduce latency in the signal detection process by selecting sub-spaces and limiting the number of constellation points to limit the frequency of node-visiting.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A method of detecting a transmit signal in a receiver in a multiple-input multiple-output (MIMO) system, comprising:
dividing a constellation space into a plurality of sub-spaces, the constellation space being determined by a channel matrix, which indicates channel characteristics of the MIMO communication system, and the number of antennas in the system; and
detecting the transmit signal by calculating a metric of at least one of the sub-spaces.

2. The method of claim 1, wherein detecting the transmit is signal comprises making early termination of the metric calculation based on a condition of a buffer which temporarily stores signals measured by the receiver.

3. A method of detecting a transmit signal in a receiver in a multiple-input multiple-output (MIMO) system, comprising:
preprocessing estimated channel characteristics of the MIMO communication system;
processing received signals measured by the receiver using the preprocessed channel-characteristic data and dividing a constellation space used to detect the transmit signal into sub-spaces; and
detecting the transmit signal by executing a statistical algorithm on at least one of the sub-spaces.

4. The method of claim 3, wherein dividing a constellation space comprises dividing the constellation space into sub-spaces in such a manner that neighboring sub-spaces partly overlap.

5. The method of claim 3, wherein detecting the transmit signal comprises executing a statistical algorithm on one or more of the sub-spaces to detect the transmit signal.

6. The method of claim 3, wherein detecting the transmit signal comprises checking a buffer temporarily storing the received signals, and making early termination of the statistical calculation so that the buffer cannot overflow.

7. The method of claim 3, wherein the statistical algorithm is a sequential signal detection method which includes a stack algorithm.

8. An apparatus for detecting a transmit signal in a receiver in a multiple-input multiple-output (MIMO) system, comprising:
a channel estimation unit which estimates channel characteristics of the MIMO communication system;
a preprocessing unit which preprocesses the estimated channel-characteristic data; and
a signal detection unit which processes a received signal measured by the receiver using the preprocessed channel-characteristic data, divides a constellation space used to detect the transmit signal into sub-spaces, and executes a statistical algorithm on at least one of the sub-spaces to detect the transmit signal.

9. The apparatus of claim 8, wherein the signal detection unit divides the constellation space into sub-spaces in such a manner that neighboring sub-spaces partly overlap.

10. The apparatus of claim 8, wherein the signal detection unit executes a statistical algorithm on one or more of the sub-spaces to detect the transmit signal.

11. The apparatus of claim 8, further comprising a buffer into which the received signal is input,
wherein the apparatus makes early termination of the statistical calculation so that the buffer cannot overflow.

12. A computer-readable recording medium to record programs for executing on a computer the method of claim 1.
